(19) United States
(12) Patent Application Publication
(10) Pub. No.: US 2010/0179960 A1
(43) Pub. Date: Jul. 15, 2010

(54) MANAGEMENT APPARATUS, INFORMATION PROCESSING APPARATUS, AND LOG PROCESSING METHOD

(75) Inventor: Nobuyuki Shigeeda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/684,049

(22) Filed: Jan. 7, 2010

(30) Foreign Application Priority Data
Jan. 9, 2009 (JP) 2009-003625

(51) Int. Cl. G06F 17/30; G06F 12/14

(52) U.S. Cl. 707/758; 707/783; 707/705; 707/E17.005; 707/E17.014

(57) ABSTRACT

A management apparatus executes service processing to job information and content information acquired by a data processing service to generate log information with a plurality of shared folders individually set with access authority for retaining the log information to be acquired from an information processing apparatus secured. Then, the management apparatus allocates and outputs the log information to one of the plurality of shared folders based on attribute information on the generated job log and a folder correspondence table.

### BACKGROUND OF THE INVENTION

1. Field of the Invention

The present invention relates to a system for searching a job log, which is managed by a management apparatus, using a search application of an information processing apparatus.

2. Description of the Related Art

There is a content information inspection system that acquires job information or content information in a copying operation, data transmission operation, and printing operation of an office imaging product to execute centralized control by a server, and searches these history information (log information) to refer to the job information or the content information later. The office imaging product includes an image processing apparatus, such as a printer, a scanner, and a multifunction peripheral (MFP).

When a user performs office business, the user uses these office imaging products. However, the office imaging product collects job information and content information for each processing, such as copying, facsimile (FAX) transmission and receiving, and printing.

In order to inspect whether the user uses the office imaging product with an inappropriate condition, an administrator searches the collected job information or content information by a keyword or an image using a log inspection system. Thus, the administrator can refer to the content of processing performed by the user.

Incidentally, the conventional log inspection system stores the acquired job information or content information in a data server which includes a database and a storage system to execute centralized management. In the configuration of the data server, the configuration of database management software and hardware of storage is complex. Thus, installation and management are difficult.

Accordingly, a simple content information inspection system (hereinafter, referred to as a “simple log inspection system”) is currently considered in which the job information and the content information are stored in a versatile file server (shared folder) instead of the data server. The simple log inspection system does not need to construct the data server and can use a file server which is used by the user as it is. Thus, installation and management are made easier.

In the simple log inspection system, in order to view the content of the job information and the content information, a versatile editor is used. The job information is a format of a text and a comma separated value (CSV) file. Thus, a text editor can be used. Further, the content information is in an image format. Thus, image viewer is used.

A management person in charge (hereinafter, referred to as an “inspector”) who performs inspection refers to the content of processing performed by the user with the office imaging product to perform inspection practice of the job information and the content information stored in the file server using these versatile applications.

Incidentally, the job information and the content information are generated for every time the user copies and prints. Thus, the number of these log information reaches an enormous amount. The inspector needs to refer to the objective log information from the enormous amount of log information. Thus, a search function is important.

Conventionally, the simple log inspection system stores an enormous amount of log information by centralizing the file server in one place. The inspector needs to perform work for searching log information that contains a specific keyword among an enormous number of log information collected in one place using a versatile text editor having the search function.

Further, in order to enable a search, an index to the log information needs to be generated beforehand. Index generation processing to a large amount of log information needs enormous time. Thus, a decrease in convenience has become a problem such that the inspector cannot immediately search when the inspector intends to search or the inspector needs to prepare a high-performance searching personal computer (PC).

Furthermore, a large amount of log information is collected and stored in a file server in one place. Thus, there is a problem that an inspection work of log information is hard to be shared by a plurality of inspectors. Still furthermore, in the log information stored in the file server in one place, the inspector can refer to all log information. Thus, there has been a problem for internal control.

Conventionally, concerning a reduction in a load of search index generation processing, a method is discussed which generates and uses a signature corresponding to the content of data (refer to Japanese Patent Application Laid-Open No. 2008-9859). Further, concerning a reference restriction to log information stored in one place, a method is discussed in which information for browsing is associated with image data to be generated by an image processing apparatus (refer to Japanese Patent Application Laid-Open No. 2005-20062).

According to Japanese Patent Application Laid-Open No. 2008-9859, prior to generation of a search index, first, a signature of data is generated. Whether this signature is consistent with a signature of already registered data is searched. When the signature is found, generation of a new search index is skipped.

However, this method requires a program with a dedicated and also complicated configuration for collating it with existing data. Further, when the index is generated, generation and collation processing of the signature are operated. Thus, a sufficient effect cannot be obtained with respect to a reduction in a load of index generation.

According to Japanese Patent Application Laid-Open No. 2005-20062, browsing information associated with image data and a processing component for executing access restriction based on this browsing information are required. Thus, the amount of data is increased, and a dedicated and also complicated log information reference program is required.

### SUMMARY OF THE INVENTION

The present invention is directed to a system capable of reducing a load of index generation for searching log information to be acquired in large quantities from an information processing apparatus.

According to an aspect of the present invention, a management apparatus for acquiring content information from an agent of a data processing apparatus to manage the content information includes a generation unit configured to generate a content log based on the content information acquired from the agent; a plurality of shared folders individually set with access authority for retaining the content log generated by the generation unit; a retention unit configured to retain correspondence information that associates a shared folder required to retain the content log with attribute information on the content log; and a log output unit configured to allocate and output the content log to one of the plurality of shared folders based on the attribute information on the content log generated by the generation unit and the correspondence information.

According to an another aspect of the present invention, an information processing apparatus for communicating with a management apparatus configured to manage a plurality of shared folders, which are individually set with access authentication, using a search application includes a login unit configured to log into one of the plurality of shared folders managed by the management apparatus with preset login information; a generation unit configured to refer to a content log retained in the shared folder logged into by the login unit to generate a search index for searching the content log; and an index retention unit configured to retain the search index generated by the generation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the configuration of an information processing apparatus according to an exemplary embodiment of the present invention.

FIG. 2 is a block diagram illustrating the configuration of a log inspection system including an information processing apparatus illustrated in FIG. 1.

FIG. 3 is a flowchart illustrating an example of a data processing procedure in an information processing apparatus according to an exemplary embodiment of the present invention.

FIG. 4 is a flowchart illustrating an example of a data processing procedure in an information processing apparatus according to an exemplary embodiment of the present invention.

FIG. 5 is a flowchart illustrating an example of a data processing procedure in an information processing apparatus according to an exemplary embodiment of the present invention.

FIG. 6 is a flowchart illustrating an example of a data processing procedure in an information processing apparatus according to an exemplary embodiment of the present invention.

FIG. 7 is a flowchart illustrating an example of a data processing procedure in an information processing apparatus according to an exemplary embodiment of the present invention.

FIG. 8 is a flowchart illustrating an example of a data processing procedure in an information processing apparatus according to an exemplary embodiment of the present invention.

FIG. 9 is a diagram illustrating the structure of log information and the dependence of each data in an information processing apparatus according to an exemplary embodiment of the present invention.

FIG. 10 is a diagram illustrating the configuration content of a folder correspondence table in a service provider illustrated in FIG. 2.

FIG. 11 is a diagram illustrating a folder information setting screen in a search application illustrated in FIG. 2.

FIG. 12 is a diagram illustrating a memory map of a storage medium that stores various types of data processing programs readable by an information inspection system according to an exemplary embodiment of the present invention.

### DESCRIPTION OF THE EMBODIMENTS

Various exemplary embodiments, features, and aspects of the invention will be described in detail below with reference to the drawings.

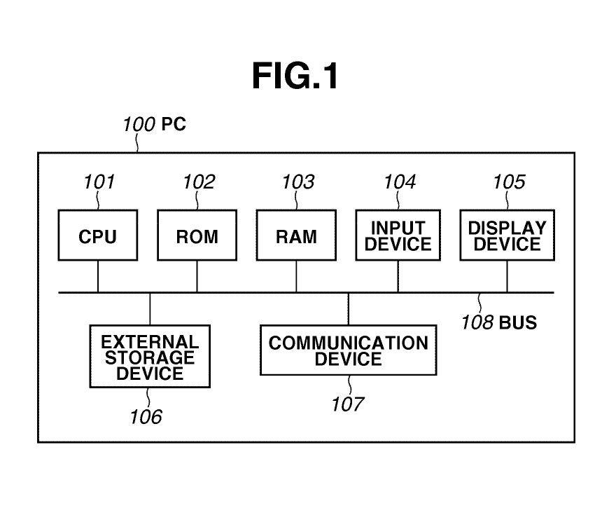

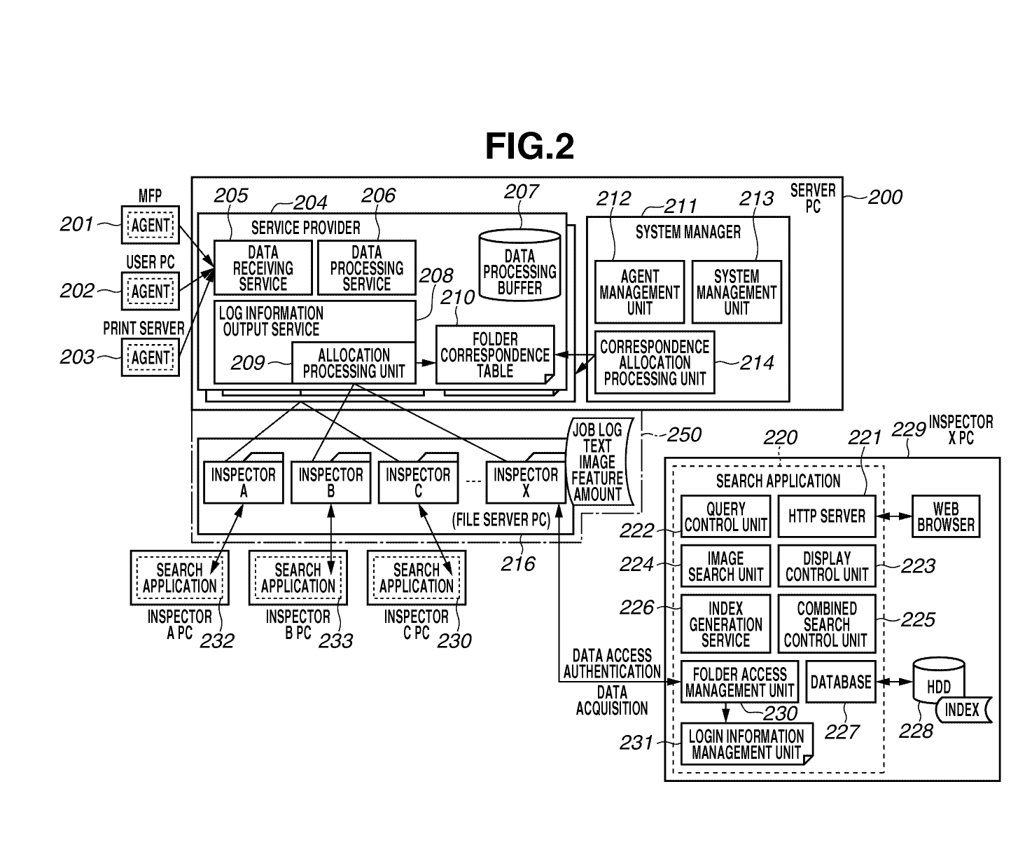

FIG. 1 is a block diagram illustrating the configuration of an information processing apparatus according to an exemplary embodiment of the present invention. The present exemplary embodiment is a configuration example of the information processing apparatus on which each component program of a simple log inspection system is operated. A user PC 202 and a print server 203 illustrated in FIG. 2, which will be described below, also include a similar hardware resource thereto.

In FIG. 1, a central processing unit (CPU) 101 executes calculation processing for various types of data processing and a search concerning log information acquisition to control each component connected to a bus 108.

A read only memory (ROM) 102 is a memory dedicated to data read and stores a basic control program for an information processing apparatus 100. A random access memory (RAM) 103 is a memory for reading and writing data. The RAM 103 is used for various types of calculation processing in the CPU 101 and temporal storage of data. An external storage device 106 is used as a system program of an operating system (OS) of the information processing apparatus 100, a program of the simple log inspection system, and a temporal storage area in process of data processing.

The external storage device 106 is slow in input/output of data compared with the RAM 103. However, the external storage device 106 can store mass data. A magnetic storage device (hard disk drive (HDD)) mainly corresponds to this. Further, the external storage device 106 includes an apparatus which connects external media such as a compact disc read only memory (CD-ROM), a digital versatile disc read only memory (DVD-ROM) and a memory card to read and record data.

An input device 104 inputs characters and data into the information processing apparatus 100. Various types of keyboards and mice correspond to this. A display device 105 displays the processing result in the information processing apparatus 100. A cathode ray tube (CRT), a liquid crystal monitor, or the like corresponds to this. A communication device 107 is connected to a local area network (LAN) to execute data communication by Transmission Control Protocol/Internet Protocol (TCP/IP). The communication device 107 is used when mutually executing communication with other information processing apparatuses.

FIG. 2 is a block diagram illustrating the configuration of an information inspection system including an information processing apparatus illustrated in FIG. 1. The present exemplary embodiment is a system example in which a server PC, a PC for each inspector, a file server PC, and an image forming apparatus are connected via a network to manage a job log. Software (module), which will be described below, is installed in the server PC, the PC for each inspector, and the file server PC. The CPU 101 illustrated in FIG. 1 loads the software into the RAM 103 to execute it, thereby realizing data processing based on respective functions. Log processing in this system will be described in detail below.

In FIG. 2, a digital multifunction peripheral (MFP) 201 includes an agent function. The agent is a module for executing the function of collecting its job information and content information to transfer outside concerning a job such as copy and FAX transmission performed by a user with the MFP 201.

A user PC 202 also includes the agent function. The user PC 202 executes collection of job information and content information for network printing. A print server 203 also includes the agent function. When the user performs printing via a print server, the print server 203 collects job information and content information.

A server PC 200 includes a service provider 204. The job information and the content information collected from each agent of the MFP 201, the user PC 202, and the print server 203 and transferred outside are transferred to the service provider 204.

The service provider 204 executes necessary data processing on the job information and the content information received from each agent. Service processing to be executed by the service provider 204 includes, for example, image format conversion, resolution conversion, and optical character recognition (OCR) processing for extracting character information from an image.

A data receiving service 205 is one of components of the service provider 204 and receives data from an agent such as the MFP 201 illustrated in FIG. 2. Then, in the data receiving service 205, the data received from the agent is temporarily stored in a data processing buffer 207. The data processing buffer 207 is installed on the hard disk of the server PC 200, on which the service provider 204 is operated.

Thus, data is temporally stored in the data processing buffer 207, thereby allowing data receiving processing and data processing, which are executed by the service provider 204, to be processed in parallel.

A data processing service 206 executes the above-described various types of data processing on the content information received from an agent such as the MFP 201. When the data processing is completed, processed data is stored in the data processing buffer 207 again. The data processing service 206 executes service processing on the job information and the content information acquired from an agent such as the MFP 201 to generate log information containing a content log. The service processing includes image format conversion, resolution conversion, and OCR processing for extracting character information from an image.

A log information output service 208 executes processing for outputting processed data to an external folder which is provided for each inspector. The external folder is a shared folder 216 included in the file server PC 250 and is provided for each inspector. The shared folder 216, which is provided for each inspector, for example, is configured with the file server PC 250, whose OS is Windows, to allow authentication setting in access to a folder. The file server PC 250 executes user authentication processing for authenticating user information in login request from a PC of an inspector, which will be described below, to a shared folder.

The log information output service 208 includes an allocation processing unit 209 for allocating log information to an output destination. The allocation processing unit 209 reads processed data from the data processing buffer 207 and executes log output processing for suitably allocating to output to a plurality of shared folders 216 according to a procedure illustrated in a flowchart which will be described below. The plurality of shared folders 216 is configured so that access authority can individually be set.

The allocating processing is executed based on information described in a folder correspondence table 210. In the folder correspondence table 210, correspondence information on a job information attribute and an allocation destination folder is described. The allocation processing unit 209 refers to information described in the folder correspondence table 210, determines the folder of a data output destination, and outputs data based on attribute information described in the job information when the processed data processed by the data processing service 206 is output.

Information described in the job information to which the allocation processing unit 209 refers includes, for example, a job execution user name. The job execution user name is the name of a user who executed the job of the job information and functions as user information. Accordingly, the allocation processing unit 209 can allocate log information to an output destination by the job execution user name.

The folder correspondence table 210 is configured so as to be set and changed by a system manager 211. The system manager 211 executes system setting of a simple log inspection system according to the present exemplary embodiment and function processing for monitoring the state of agent information.

The system setting is set and managed by a system management unit 213, and the agent is set and managed by an agent management unit 212. On the other hand, a correspondence allocation processing unit 214 is included in the system manager 211 and sets the content of the folder correspondence table 210 of the service provider 204.

One or more service providers 204 can be installed. Thus, in order to execute consistent allocation processing of log information to an output destination, the correspondence allocation processing unit 214 sets the same content to all of the folder correspondence tables 210.

A system administrator sets and changes allocation destination folder designation for each inspector using the system manager 211 in the server PC 200. The correspondence allocation processing unit 214 notifies all service providers 204 of this content. Thus, each folder correspondence table 210 is set and changed.

The service provider 204 and the system manager 211 can be installed on the same server PC. Further, a file server 215, which configures the shared folder 216, may be included on the same server PC including the service provider 204 and the system manager 211. The file server 215 can be included as a different node.

Furthermore, processed data processed by the data processing service 206 is output to the shared folder 216 by the allocation processing unit 209 and stored therein. The processed data includes job information, content information applied with image processing, text information obtained by executing OCR processing, and image feature amount information extracted from the content information.

Still furthermore, the image feature amount information is used for determining similarity of an image in image search processing.

The job information and the content information collected by agent such as the MFP 201 are stored in the shared folder 216 designated by the correspondence allocation processing unit 214 via necessary processing. Since a large quantity of log information is accumulated, in order to search log information necessary for an inspector, a search application 220 illustrated in FIG. 2 is used.

The search application 220 is installed on a PC 229 of an inspector to be used for each inspector. This intends to restrict the range of log information to be referred to for each inspector. A search application 232 for an inspector A, a search application 233 for an inspector B, and a search application 234 for an inspector C refer to log information stored in each different shared folder in the file server PC 215.

The search application 220 is configured so as to allow the function of a simple hypertext transfer protocol (HTTP) server 221 to be executed to allow a search function to be used from a web browser. A query control unit 222 designated a search condition to the shared folder 216. A display control unit 223 generates a hypertext markup language (HTML) to output a display screen to the web browser.

An image search unit 224 uses an image feature amount extracted from content information to execute image search processing to image information stored in a shared folder. A combined search control unit 225 combines three types of search of attribute search due to a job information attribute, full text search to text data extracted from content information, and previous image search to efficiently execute search.

A folder access management unit 230 controls access authentication when the search application 220 accesses the shared folder 216 and input/output processing of data. The search application 220 includes a login information management unit 231 to be used when accessing the preset shared folder.

The folder access management unit 230 refers to login information in the login information management unit 231 to execute login authentication to the shared folder 216.

When login authentication to the shared folder 216 is successful, an index generation service 226 generates an index for searching log information stored in the shared folder 216. The generation of the index is executed by referring to job information and text information stored in the shared folder 216.

Then, the generated index is managed by a database 227 included in the search application 220. The data is actually stored in a hard disk drive (HDD) 228. The database 227 functions as an index retention unit.

The search application 220 can also store index data in the shared folder 216 in which log information has been stored after the index is generated. By configuring in this way, log information and index information can easily be backed up in a mass.

In a system example illustrated in FIG. 2, a search index is configured to be stored in the HDD 228 in the PC 229 of an inspector X. Further, an access right can be set to the shared folder 216 in advance. The search application 220 needs to designate authentication information for access authentication when accessing the shared folder 216.

Thus, to the search application 220, authentication information concerning the inspector who uses the application can be set in advance, and when accessing the shared folder 216, the authentication information is provided to the shared folder 216 as a program, and authentication is executed.

The search application 220 executes index generation processing only when access authentication to the shared folder 216 has been successful.

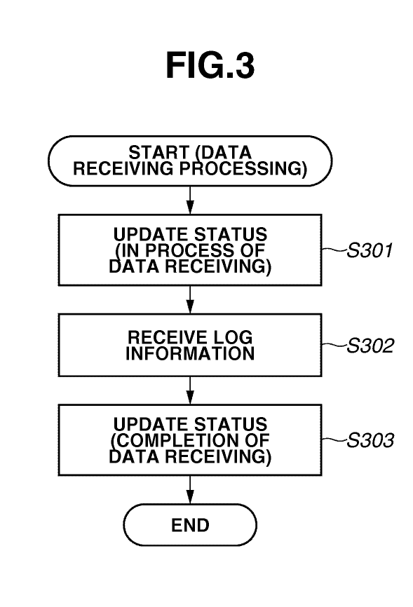

FIG. 3 is a flowchart illustrating an example of a data processing procedure in an information processing apparatus according to the present exemplary embodiment. The present exemplary embodiment is an example of a data receiving processing flow in the service provider 204. The data receiving flow is controlled by the data receiving service 205 illustrated in FIG. 2.

Each step is realized by causing the CPU in the server PC 200 to execute a module loaded into a RAM. Hereinafter, as description, data processing based on each module illustrated in FIG. 2 will be described.

In step S301, the data receiving service 205 updates a status to “in process of data receiving” in order to notify another processing process of that which is in the midst of receiving data from an agent in each image processing apparatus or the PC 215. The received data is stored in the data processing buffer 207. However, the data receiving service 205 can control so as not to access data in process that another process receives by the status. A processing status is associated with the received data and managed for each received data.

Next, in step S302, the data receiving service 205 receives log information data from the agent of the MFP 201. As the log information data, each data binary with a text can be received using a web service technique. Further, in order to guarantee consistency of transmitted and received data, state transition control of data transmission and receiving is executed.

Thus, when receiving of the log information data is completed, in step S303, the data receiving service 205 updates the status to “completion of data receiving” in order to notify another processing process of completion of data receiving. Then, this processing ends.

The another processing process is the data processing service 206 and starts various types of data processing to data that the status has been provided by completion of data receiving.

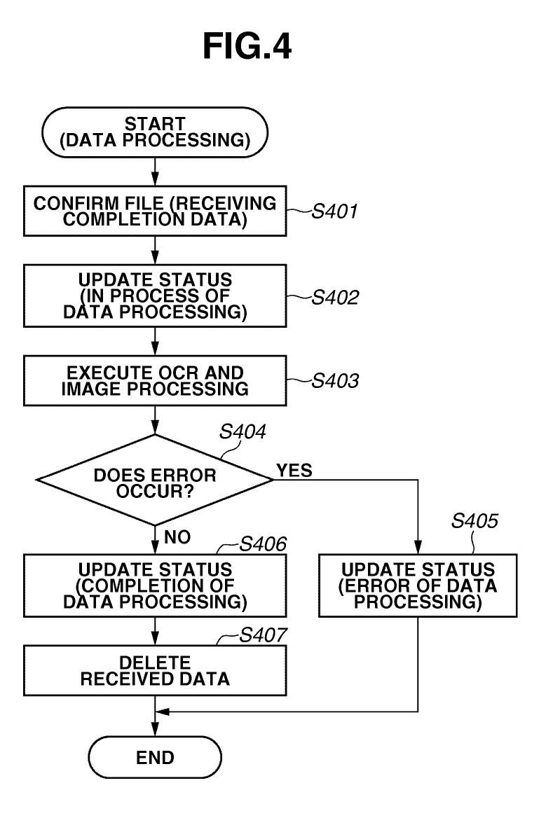

FIG. 4 is a flowchart illustrating an example of a data processing procedure in an information processing apparatus according to the present exemplary embodiment. The present exemplary embodiment is a processing example of the data processing service 206 illustrated in FIG. 2. This processing is controlled by the data processing service 206. Each step is realized by causing the CPU in the server PC 200 to execute a module loaded into a RAM. Hereinafter, as description, data processing based on the data processing service 206 illustrated in FIG. 2 will be described.

In step S401, the data processing service 206 periodically monitors received data stored in the data processing buffer 207 and confirms whether data for which data receiving has been completed is present. When the data processing service 206 finds data for which receiving has been completed by this confirmation processing, then in step S402, the data processing service 206 updates the status of the data file to “in process of data processing”. Thus, the status “in process of data processing” is provided, thereby allowing control so that a plurality of processing processes does not scramble for one received data when the plurality of processing processes is operated.

Next, in step S403, the data processing service 206 executes OCR processing and various types of image processing to received data to be read from the data processing buffer 207. The received data includes job information and content information. Further, the content information includes image data. Furthermore, the image data may be large in size. Thus, in this case, the data processing service 206 executes resolution conversion to execute image processing for reducing the data size of the image data.

Still furthermore, in order that an inspector easily refers to the image data afterward, the data processing service 206 executes image processing for converting an image format into a versatile format.

For example, the data processing service 206 converts the image data into Joint Photographic Experts Group (JPEG) image data to subject the format to, for example, a PDF. The PDF corresponds to a portable document format developed by Adobe Systems Incorporated.

On the other hand, in order to extract character information to be contained in the image data, the data processing service 206 executes image processing such as OCR processing. The extracted character information is used when the inspector performs full text search afterward.

Next, in step S404, the data processing service 206 determines whether some types of error occur in the OCR or image processing. When the data processing service 206 has determined that an error occurs, then in step S405, the data processing service 206 updates the status to “error of data processing”. Then, this processing ends. When it is the status “error of data processing”, the processing process skips processing to the data to execute processing to another data.

On the other hand, in step S404, when the data processing service 206 has determined that an error does not occur, then in step S406, the status is updated to “completion of data processing”. Next, in step S407, the data processing service 206 deletes the received data since it is unnecessary. Then, this processing ends. The processed data that has reached the status “completion of data processing” is stored in the data processing buffer 207 again to be submitted for log information output processing.

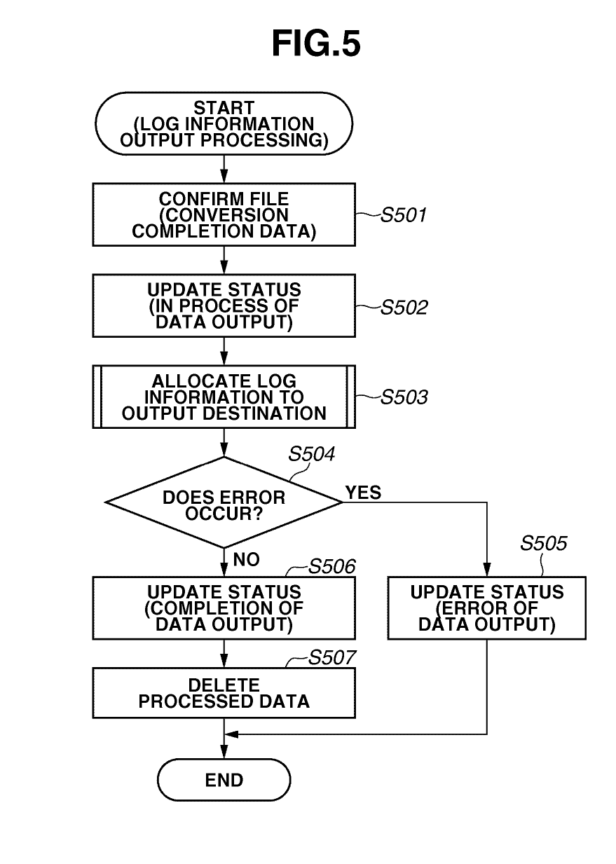

FIG. 5 is a flowchart illustrating an example of a data processing procedure in an information processing apparatus according to the present exemplary embodiment. The present exemplary embodiment is an example of log information output processing in the log information output service 208. Each step is realized by causing the CPU in the server PC 200 to execute a module loaded into a RAM. Hereinafter, as description, data processing based on the log information output service 208 illustrated in FIG. 2 will be described.

First, in step S501, the log information output service 208 monitors processed data stored in the data processing buffer 207 to periodically confirm the presence or absence of the file of the status “completion of data processing”. Then, in step S502, when the log information output service 208 finds processed data, the log information output service 208 updates the status of the data to “in process of data output”.

Next, in step S503, the log information output service 208 is controlled by the allocation processing unit 209 to execute allocation processing of log information to an output destination for outputting data-processed log information to the shared folder 216 according to the content of the folder correspondence table 210. The detail of the allocation processing process of the log information to an output destination will be described below. Further, in the present exemplary embodiment, the data-processed log information is output to a shared folder for each inspector to be secured in the file server PC 215.

Next, in step S504, the log information output service 208 determine whether an error occurs in the processing for allocating log information to an output destination. When the log information output service 208 has determined that an error occurs in the processing for allocating log information to an output destination, the status is updated to “error of data output”. Then, this processing ends. When the log information output service 208 has determined the status “error of data output”, the processing process skips processing to the data.

On the other hand, in step S504, when the log information output service 208 has determined that data output processing ends normally and an error does not occur, the processing proceeds to step S506. Then, in step S506, the log information output service 208 updates the status to “completion of data output”. In step S507, the log information output service 208 deletes the processed data. Then, this process ends.

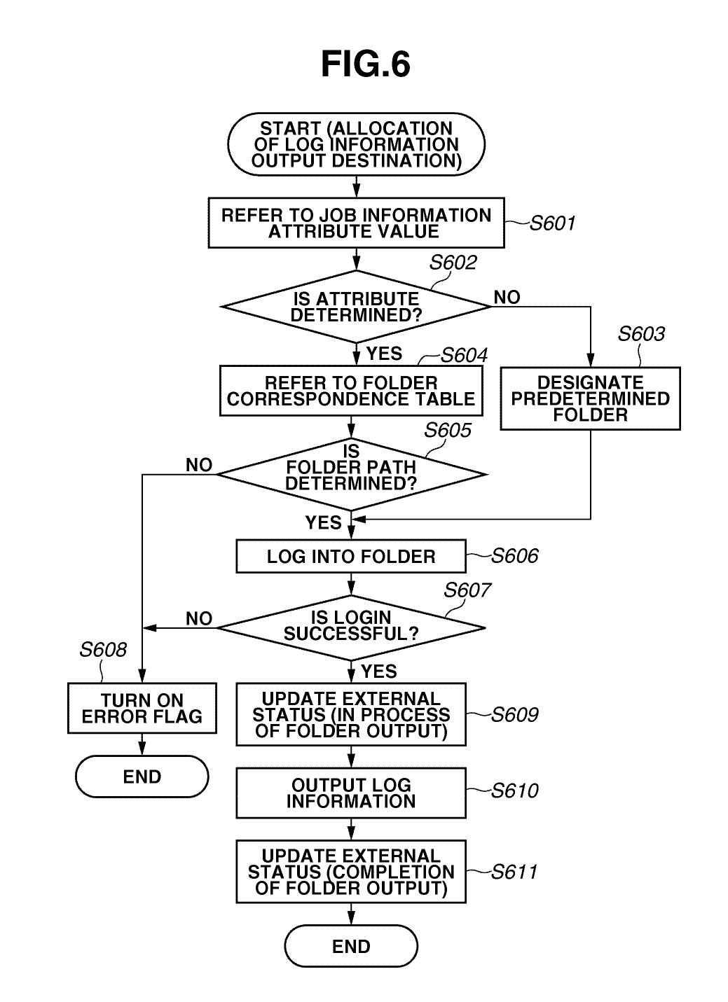

Next, allocating processing of log information to an output destination indicated in step S503 will be described using FIG. 6.

FIG. 6 is a flowchart illustrating an example of a data processing procedure in an information processing apparatus according to an exemplary embodiment of the present invention. The present exemplary embodiment is the detail example of the allocating processing of log information to an output destination. Each step is realized by causing the CPU in the server PC 200 to execute a module loaded into a RAM. Hereinafter, as description, data processing based on the log information output service 208 illustrated in FIG. 2 will be described below. Further, this processing is operated in the processing process of the log information output service 208 illustrated in FIG. 2. Furthermore, this processing is controlled by the allocation processing unit 209 configured to allocate log information to an output destination which is involved by the log information output service 208.

First, in step S601, the allocation processing unit 209 refers to an attribute value to be contained in job information. For example, the allocation processing unit 209 executes processing that refers to a user name in job information to extract an attribute value. Which attribute to be referred to can be changed by setting in advance. The user name in job information corresponds to a job execution user name. Thus, in this case, it can be determined that a set of log information is output to which shared folder 216 for each job execution user.

Then, in step S602, the allocation processing unit 209 determines whether it has been determined which attribute needs to be referred to. When the attribute value is null, the allocation processing unit 209 determines that it is unable to be determined which attribute needs to be referred to. Then, the processing proceeds to step S603.

Then, in step S603, the allocation processing unit 209 designates the predetermined folder. Then, the processing proceeds to step S606. As the predetermined folder, a folder is designated which has been determined in advance when allocation cannot be executed by the folder correspondence table 210.

On the other hand, in step S602, when the allocation processing unit 209 has determined that it is able to be determined which attribute needs to be referred to, that is when it has been determined that the attribute value is able to be extracted, the processing proceeds to step S604.

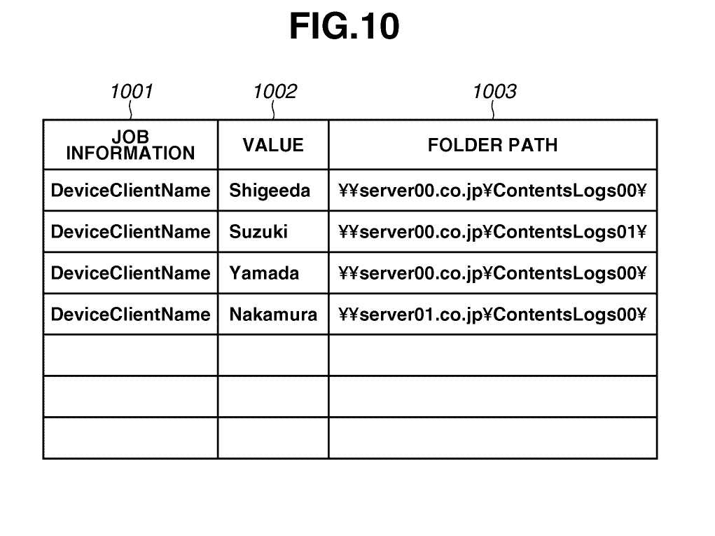

Then, in step S604, the allocation processing unit 209 refers to the content of the folder correspondence table 210 in order to determine the output destination of log information to determine a folder path of the destination to which data is output. In the folder correspondence table 210 including a data structure illustrated in FIG. 10, an attribute value contained in the job information attribute and folder path information associated with the attribute value are described.

Next, in step S605, the allocation processing unit 209 determines whether the folder path has been determined. If the allocation processing unit 209 determines the folder path by referring to the folder correspondence table 210, the processing proceeds to processing for actually outputting data. However, if the folder path is not determined, the processing proceeds to step S608. Then, in step S608, the allocation processing unit 209 turns an error flag to ON and executes error processing. Then, this processing ends.

On the other hand, in step S605, when the allocation processing unit 209 has determined that the folder path is determined, the processing proceeds to step S606.

Then, in step S606, the allocation processing unit 209 executes login processing to the shared folder 216 to which access authority which is secured on the file server PC 215 is set. User identification data (ID) and a password are different for each shared folder. In the present exemplary embodiment, these are described in the folder correspondence table 210 with the folder path.

Specifically, when the allocation processing unit 209 refers to the folder path in the processing for referring to a folder correspondence table in step S604, the allocation processing unit 209 acquires access information together therewith to execute login processing using the acquired access information.

Next, in step S607, the allocation processing unit 209 determines whether the login processing to the folder has been successful. When the allocation processing unit 209 has determined that the login processing has resulted in failure, the processing proceeds to step S608. The allocation processing unit 209 turns the error flag to ON. Then, this process ends. Thereafter, in step S504, the log information output processing is controlled so as to execute error processing.

On the other hand, in step S607, when the allocation processing unit 209 has determined that the login has been successful, the processing proceeds to step S609 in order to actually execute data output processing.

Then, in step S609, the allocation processing unit 209 updates the status (external status) of output data that is output to the shared folder 216 prior to data output to “in process of folder output”. Thus, data in process of output to the shared folder 216 can be prevented from being referred to by an external processing process, for example, a search application.

Next, in step S610, the allocation processing unit 209 outputs log information to the shared folder 216. At this time, the allocation processing unit 209 outputs the log information to the shared folder 216 using a file transfer protocol. The protocol to be used includes Server Message Block (SMB) and File Transfer Protocol (FTP).

Then, after the allocation processing unit 209 completes processing for outputting the log information to the shared folder 216, then in step S611, the allocation processing unit 209 updates an external status that is managed by the data processing buffer 207 to “completion of folder output”. With the status “completion of folder output”, the external processing process can start processing to the output data.

Log information acquired by an agent such as the MFP 201 ends when the log information is passed through all processing steps of the service provider 204 to be output to the shared folder 216. Log information stored in each shared folder 216, which is provided for each inspector, is referred to when the search application 220 in the PC 229 that, for example an inspector X operates generates an index.

Further, in the server PC 200, backup and deletion of data are executed according to an existing software program and a processing procedure complying with the operating policy of a system administrator.

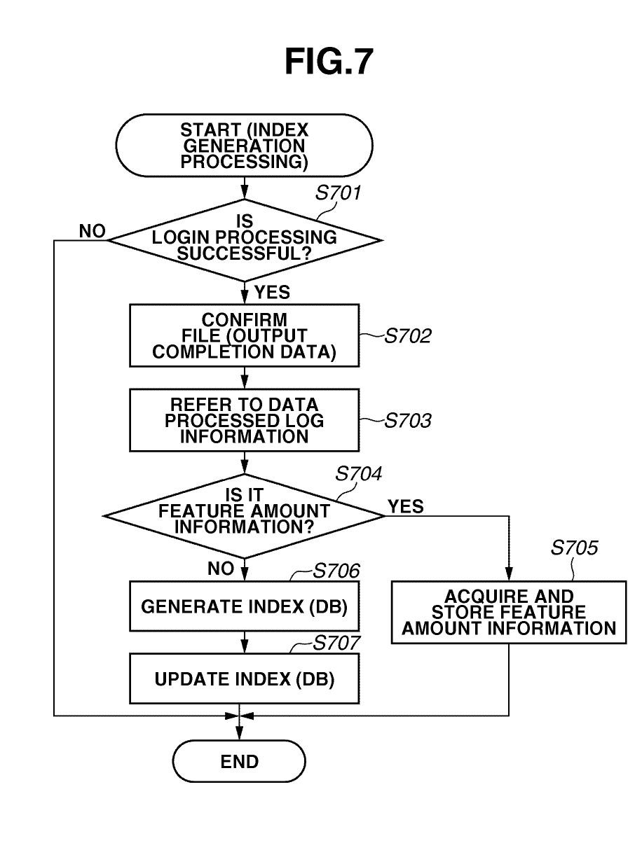

FIG. 7 is a flowchart illustrating an example of a data processing procedure in an information processing apparatus according to the present exemplary embodiment. The present exemplary embodiment is a detail example of processing in which the search application 220 generates an index. The search application 220 is a software program which operates on the PC of an inspector. The search application 220 accesses log information stored in the shared folder 216 in timing designated in advance to generate the index.

For example, index generation processing is periodically executed in the midst of starting the search application 220. Each step is realized by causing the CPU in the PC 229 to execute a module loaded into a RAM.

First, when accessing the shared folder 216, login processing is executed by the processing process of the search application 220. In step S701, the search application 220 determines whether login has been successful. If the login has resulted in failure, the search application 220 outputs a message of failure. Then, the processing ends.

On the other hand, in step S701, when it has been determined that the login processing has been successful, then in step S702, the search application 220 confirms whether data whose external status is “completion of data output” is present in the shared folder 216.

Then, in step S703, the search application 220 refers to data in order starting with data whose external status is “completion of data output” to shift to index generation processing for search.

Then, in step S704, the search application 220 determine whether job information data and text data are contained in the referred-to data, that is, feature amount information is contained, based on data reference processing in step S703. If the search application 220 has determined that the feature amount information is contained in the referred-to data, then in step S705, the search application 220 stores index data on job information and text data in the database 227. Then, this processing ends.

More specifically, in step S704, if the search application 220 has determined that the referred-to log information is image feature amount data, then in step S705, the search application 220 stores the image feature amount data in the database 227. For the job information and the text data, the search application 220 executes attribute search or full text search using the generated index. For the image feature amount, the search application 220 uses it for image search.

On the other hand, in step S704, if the search application 220 has determined that feature amount data is not contained, the processing proceeds to step S706. The search application 220 executes a series of index generation processing.

A series of index generation processing is executed to all data stored in the shared folder 216. In the search application 220, an index generation processing status is managed for each data. Thus, even when the search application 220 interrupts index generation, next, generation of the index can be restarted from that in which the search application 220 has been interrupted. Further, after once generation of the index is completed, generation of the index can also additionally be executed to the data newly output to the shared folder 216.

Next, in step S707, the search application 220 executes update processing of the generated index. Then, the processing ends.

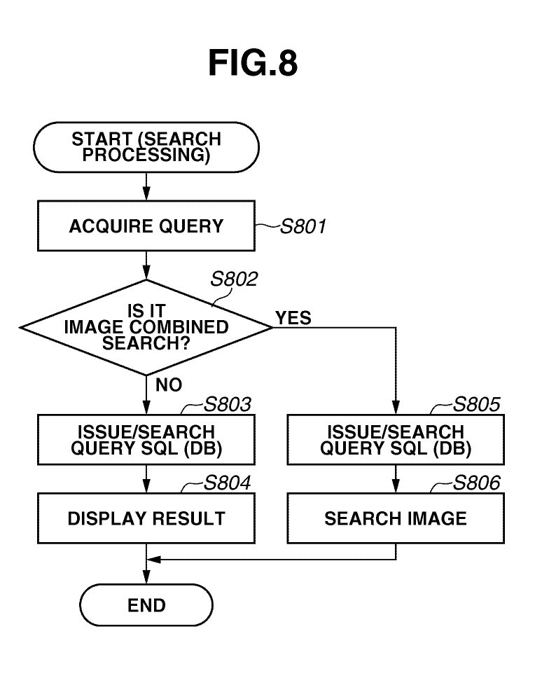

FIG. 8 is a flowchart illustrating an example of a data processing procedure in an information processing apparatus according to an exemplary embodiment of the present invention. The present exemplary embodiment is a detail example of search processing in the search application 220. The search application 220 is configured by a web application. Thus, the search application 220 starts a web browser on the PC 229 of an inspector to execute a search application function. Each step is realized by causing the CPU in the server PC 229 to execute a module loaded into a RAM.

First, an inspector on the PC 229 designates a keyword and a conditional expression in order to search the referred-to log information by search. Then, in step S801, the search application 220 acquires query information from the keyword and the conditional expression designated by the inspector. Then, in step S802, the search application 220 determines whether the search is a combined search including image search. When it is the image search, an image itself is designated as a query. Thus, the search application 220 determines whether a query image is designated in conditions.

When the search application 220 has determined that an image query is absent, the processing proceeds to step S803. Then, in step S803, the search application 220 executes only attribute search and full text search. Then, the search application 220 executes the attribute search and the full text search to the database 227. In step S804, the search application 220 displays a search result on a web screen. Then, this processing ends.

On the other hand, in step S802, when the search application 220 has determined to execute a combined search containing image search, the processing proceeds to step S805. Then, in step S805, the search application 220 first issues a query SQL for attribute search and full text search. This intends to reduce the object population of the image search to decrease a processing load. SQL is an abbreviation of structured query language and one of languages for executing operation of a relational database.

Then, in step S806, the search application 220 executes image search for the population narrowed by the attribute search and the full text search. Then, the processing proceeds to step S804. The image search is realized by known algorithm and processing flows.

Thus, an inspector can search log information accumulated in large quantities, directly refer to data that hits job information and content information have been stored in a shared folder, and actually view the content (job information, document image, and text).

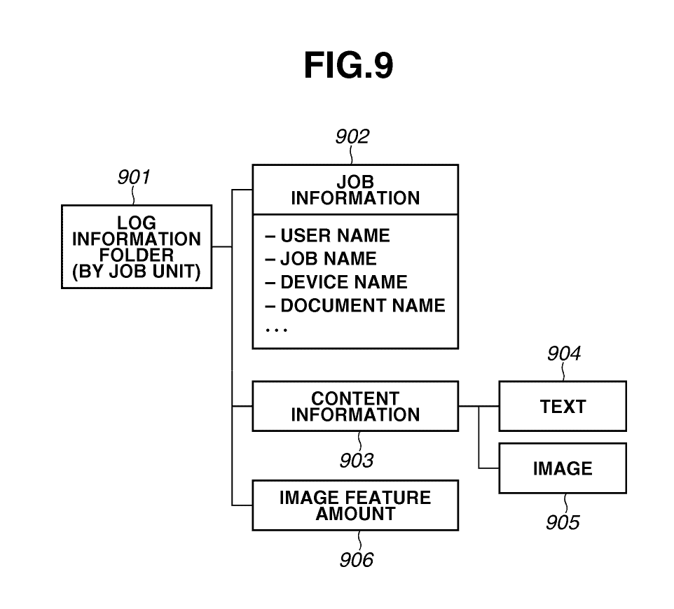

FIG. 9 is a diagram illustrating the structure of log information and the dependence of each data in an information processing apparatus according to the present exemplary embodiment. The present exemplary embodiment illustrates the structure of log information and the dependence of each data to be output to a shared folder after data processing.

In FIG. 9, log information includes job information 902, content information 903, and an image feature amount 906. The dependence of each data is managed by a log information folder 901 to be generated for each job. The log information is output to the shared folder 216 by each log information folder 901.

The job information 902, the content information 903, and the image feature amount 906 stored in the log information folder 901 are log information each is associated with the same job.

On the other hand, the content information 903 further includes text information 904 and image information 905. The text information 904 and the image information 905 are generated by the data processing service 206 in FIG. 2.

Further, the job information 902 is structured data described by a text format, and includes attribute information concerning a job such as a user name, a job name, a device name, and a document name. These types of attribute information are set by an office imaging product, a print driver, or a user PC on which a print driver is operated. The data receiving service 205 acquires those from an agent.

FIG. 10 is a diagram illustrating the configuration content of the folder correspondence table 210 in a service provider illustrated in FIG. 2. The present exemplary embodiment is an example of correspondence information associating path information to a shared folder required to retain a content log with attribute information on the content log.

In FIG. 10, job information 1001 is included in the folder correspondence table 210 to which the allocation processing unit 209 configured to allocate log information to an output destination refers. The job information includes a job execution user name, a file name, an organization unit name, a device name, and the like as attribute information of the job. The job attribute of the job information 1001 defines the job execution user name.

A value of attribute information 1002 is a value to be referred to as job information. Further, a shared folder path 1003 is a destination in which the allocation processing unit 209 configured to allocate log information to an output destination stores log information.

According to the configuration illustrated in FIG. 10, log information in which an attribute is a job execution user name and a value is Shigeeda is designated to be stored in a shared folder ¥¥server00.co.jp¥ContentsLogos00¥.

Further, log information in which an attribute is a job execution user name and a value is Nakamura is designated to be stored in a shared folder ¥¥server01.co.jp¥ContentsLogos00¥.

The allocation processing unit 209 configured to allocate log information to an output destination in this way refers to the folder correspondence table 210, switches a shared folder which outputs log information for each job information, and outputs it.

Authentication information which is necessary for the service provider 204 to log into respective shared folders is separately retained and managed inside the service provider 204 (not illustrated).

Further, in FIG. 10, as attribute information on the job information 1001, a job execution user name is set. However, another attribute information can be set.

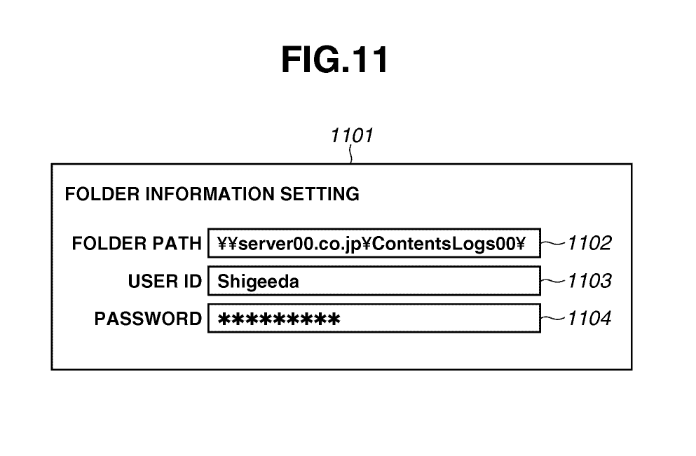

FIG. 11 is a diagram illustrating a folder information setting screen in the search application 220 illustrated in FIG. 2. The present exemplary embodiment is an example of a user interface which is displayed on a display device which is included in a PC for each inspector and an screen example that the search application 220 provides.

As illustrated in FIG. 11, when a setting link of the search application 220 configured as a web application is opened, a folder information setting screen 1101 is displayed on a web browser. The folder information setting screen 1101 may be displayed as one of a plurality of frames configured by a frame structure.

The folder information setting screen 1101 includes a folder path information setting field 1102 configured to set path information to the shared folder 216, a user ID setting field 1103 configured to set user ID information necessary to log into the shared folder 216, and a password setting field 1104.

The content of the folder information setting screen 1101 is different for each inspector. When an inspector uses the search application 220, the inspector first sets respective information by the folder information setting screen 1101. Log information that is searched by the inspector using the search application 220 is restricted to only a shared folder set on the folder information setting screen 1101.

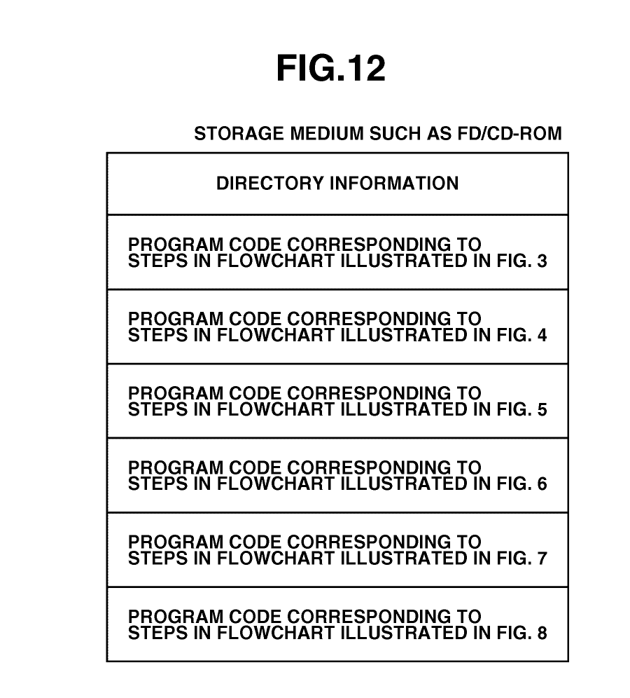

FIG. 12 is a diagram illustrating a memory map of a storage medium which stores various types of data processing programs readable by an information inspection system according to an exemplary embodiment of the present invention.

Although not particularly illustrated, information that manages a program group to be stored in a storage medium, for example, version information and information that also stores a programmer or the like and also depends on an OS or the like on the program read side, for example, an icon which identifies to display a program, may also be stored.

Further, data which is subject to various types of programs is also managed by the above-described directory. Furthermore, a program for installing various types of programs in a computer and a program to unzip a compressed program when a program to be installed is compressed may also be stored.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-003625 filed Jan. 9, 2009, which is hereby incorporated by reference herein in its entirety.

What is claimed is:

1. A management apparatus for acquiring content information from an agent of a data processing apparatus to manage the content information, the management apparatus comprising:
a generation unit configured to generate a content log based on the content information acquired from the agent;
a plurality of shared folders individually set with access authority for retaining the content log generated by the generation unit;
a retention unit configured to retain correspondence information that associates a shared folder required to retain the content log with attribute information on the content log; and
a log output unit configured to allocate and output the content log to one of the plurality of shared folders based on the attribute information on the content log generated by the generation unit and the correspondence information.

2. The management apparatus according to claim 1, wherein the correspondence information includes attribute information on the content log and path information for outputting the content log to one of the plurality of shared folders.

3. The management apparatus according to claim 2, wherein the attribute information on the content log is user information for specifying a job execution user.

4. The management apparatus according to claim 1, wherein the data processing apparatus includes one of an image processing apparatus and an information processing apparatus.

5. The management apparatus according to claim 1, further comprising a user authentication unit configured to authenticate a user who logs in from the information processing apparatus to one of the plurality of shared folders.

6. An information processing apparatus for communicating with a management apparatus configured to manage a plurality of shared folders, which are individually set with access authentication, using a search application, the information processing apparatus comprising:
a login unit configured to log into one of the plurality of shared folders managed by the management apparatus with preset login information;
a generation unit configured to refer to a content log retained in the shared folder logged into by the login unit to generate a search index for searching the content log; and
an index retention unit configured to retain the search index generated by the generation unit.

7. A log processing method for a management apparatus for acquiring content information from an agent of a data processing apparatus to manage the content information, the management apparatus including a plurality of shared folders individually set with access authority for retaining a content log, and a retention unit configured to retain correspondence information that associates a shared folder required to retain the content log with attribute information on the content log, the log processing method comprising:
generating the content log based on the content information acquired from the agent; and
allocating and outputting the content log to one of the plurality of shared folders based on attribute information on the generated content log and the correspondence information.

8. The log processing method according to claim 7, wherein the correspondence information includes attribute information on a content log and path information for outputting the content log to one of the plurality of shared folders.

9. The log processing method according to claim 7, wherein the attribute information on the content log is user information for specifying a job execution user.

10. The log processing method according to claim 7, wherein the data processing apparatus includes one of an image processing apparatus and an information processing apparatus.

11. The log processing method according to claim 7, further comprising authenticating a user who logs into one of the plurality of shared folders.

12. A log processing method for an information processing apparatus for communicating with a management apparatus configured to manage a plurality of shared folders, which are individually set with access authority, using a search application, the log processing method comprising:
logging into one of the plurality of shared folders managed by the management apparatus with preset login information;
generating referring to a content log retained in the logged-in shared folder to generate a search index for searching the content log; and
retaining the generated search index in a retention unit.

13. A computer-readable storage medium storing a program for causing a computer to execute the log processing method according to claim 7.

14. A computer-readable storage medium storing a program for causing a computer to execute the log processing method according to claim 12.
